(19) United States
(12) Patent Application Publication
(10) Pub. No.: US 2023/0067247 A1
(43) Pub. Date: Mar. 2, 2023

(54) AIR CLEANING SYSTEM AND METHOD

(71) Applicant: Eleazar Benjamin Ruiz y Avila, Washington, DC (US)

(72) Inventor: Eleazar Benjamin Ruiz y Avila, Washington, DC (US)

(21) Appl. No.: 17/826,361

(22) Filed: May 27, 2022

Related U.S. Application Data
(60) Provisional application No. 63/236,351, filed on Aug. 24, 2021.

(51) Int. Cl. B01D 53/84; B01D 53/62

(52) U.S. Cl. CPC B01D 53/84; B01D 53/62; B01D 2257/504; B01D 2258/06; B01D 2251/95

(57) ABSTRACT

An air cleaning system for removing carbon dioxide from polluted air and generating oxygen as a biproduct. A plurality of diatoms in water are held within a transparent vessel. Polluted air is injected into the water and is aerated with nanobubbles. The flow of air into the vessel is regulated to control the flow of nutrients to the diatoms. A light source provides light to permit the diatoms to use photosynthesis to consume the pollutants in the injected air and generate oxygen as a biproduct. The generated oxygen diffuses or bubbles out of the solution and is released from the system back into the atmosphere. A method of treating polluted air and generating oxygen as a byproduct using the air cleaning system is also provided.

### CROSS-REFERENCE TO RELATED APPLICATION

The present application claims priority to, and the benefit of, U.S. Provisional Application No. 63/236,351, which was filed on Aug. 24, 2021 and is incorporated herein by reference in its entirety.

### BACKGROUND

The present invention generally relates to an a system for purifying polluted air, and more specifically to a diatomic air cleaning and oxygen generating system. Accordingly, the present specification makes specific reference thereto. However, it is to be appreciated that aspects of the present invention are also equally amenable to other like applications, devices, and methods of manufacture.

Air pollution is consistently contributing to climate change and essentially ruining the environment for future generations. People and industry are not doing enough to prevent air pollution, ultimately resulting in poor air quality and no clean water to drink. Carbon dioxide, or CO2, contributes to air pollution in its role in the greenhouse effect. Carbon dioxide traps radiation at ground level, creating ground-level ozone and exacerbating global warming. A suitable solution is needed to maintain clean, breathable air and reduce greenhouse gasses.

Air purification is attempted through many natural and man-made mechanisms. Trees and plants are adept at locking away carbon dioxide from the atmosphere while producing oxygen as a byproduct. Carbon capture technologies created by people are another way of using systems to remove pollutants. Diatoms are probably the largest natural producers of oxygen on the planet by way of carbon fixation.

Diatoms are a group of algae, specifically microalgae, found in the oceans, waterways, and soils of the world. Living diatoms make up a significant portion of the Earth's biomass and generate approximately 50 percent or more of the oxygen produced on the planet each year. These organisms also take in and consume billions of metric tons of silicon each year from the waters in which they live and constitute approximately half of the organic material found in the oceans. Since diatoms are able to photosynthesize, they convert dissolved carbon dioxide in the water into oxygen while fixing the carbon. Diatoms have cell walls composed of transparent, opaline silica.

Diatoms are silicified algae of small size. Functionally, they are single cells even though they can appear as filaments, chains, or colonies, either in the water column (phytoplankton) or attached to any single substratum (benthos). The siliceous cell wall encloses the organs of the cell and has ornamented and complex structures. The siliceous wall is transparent, allowing the entrance of the light, and perforated, making possible the diffusion and excretion of materials. Diatoms need light to grow and eat organic wastes like nitrates (NO3-) and phosphates (PO4) out of the water column. Diatoms get most of their energy from sunlight during photosynthesis, but they also require a few other key nutrients. Diatoms need silica to build their cell walls, and phosphate and nitrogen.

Through carbon fixation, diatoms remove carbon dioxide from the atmosphere. The CO2 is converted to organic carbon in the form of sugar, and oxygen is released. People and animals breathe the oxygen that diatoms release. Diatoms are tiny unicellular plants, typically no bigger than half a millimeter, which inhabit the surface water of the world's oceans where sunlight penetration is plenty. Despite their modest size, they are one of the world's most powerful resources for removing carbon dioxide from the atmosphere. They currently remove, or “fix,” approximately 10-20 billion metric tons of CO2 every year by the process of photosynthesis.

Accordingly, there is a great need for simple natural method of generating clean, breathable oxygen. There is also a need for a way to remove CO2 and other pollutants from the polluted air. Similarly, there is a need for an air cleaning system that allows users to inject polluted air into water and receive clean air after processing. There is also a need for an air cleaning system that that functions in low light or at night. Further, there is a need for a natural based air cleaning system that removes CO2 from injected polluted air.

In this manner, the improved air cleaning system of the present invention accomplishes all of the forgoing objectives, thereby providing an easy solution for removing CO2 from the polluted air using diatoms. A primary feature of the present invention is a system designed to allow diatoms to ‘eat’ the CO2 prior to the air being pumped back into the atmosphere as clean oxygen. The present invention utilizes a solar panel assembly designed to power the system and LED lights that can illuminate at nighttime or other lowlight hours of the day. Finally, the improved of the present invention is capable of pushing polluted air and water through the system for cleaning via the diatoms to generate clean, breathable oxygen.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an air cleaning system for removing pollutants from air and generating oxygen as a biproduct. The air cleaning system is configured to use a plurality of diatoms to consume pollutants such as CO2 in the polluted air via photosynthesis generating oxygen as a byproduct. The consumed pollutants are used by the diatoms to live and reproduce.

The air cleaning system comprises a recipient vessel. The recipient vessel is transparent and configured to retain a liquid solution and the plurality of diatoms. The liquid solution may be seawater or freshwater depending on the species of the plurality of diatoms used. The recipient vessel comprises an inlet and an outlet. The air cleaning system may further comprise a base. The base is configured to support the recipient vessel.

The air cleaning system further comprises an air injecting component and an aeration component. The air injecting component may be a vacuum pump. The air injecting component is configured to draw polluted air into the recipient vessel via the inlet from the atmosphere. The aeration component may be a nanobubble pump. The aeration component is configured to aerate the liquid solution in the recipient vessel. The air cleaning system may further comprise an air regulator. The air regulator is configured to regulate a flow of the polluted air into the recipient vessel, thereby regulating a food source for the plurality of diatoms. The food source is the pollutants in the drawn polluted air.

The air cleaning system further comprises a lighting component and a power component. As diatoms require light for photosynthesis to consume pollutants and generate oxygen, the lighting component is used to supplement natural light or provide an independent light source during low light hours or at night, The lighting component is configured to illuminate the recipient vessel and may be internally or externally located. The power source is configured to power the lighting component, the air injecting component, the aeration component, and the air regulator. The power source is a solar power element, a battery, an electrical cable, or a combination thereof.

The air cleaning system further comprises a diatom carcass extractor. The diatom carcass extractor is housed partially within the recipient vessel. The diatom carcass extractor comprises a funnel portion and a carcass retaining portion. The funnel portion is configured to receive a plurality of diatom carcasses as the diatoms die and flow downward in the recipient vessel. The funnel portion comprises a plurality of orifices. The plurality of orifices are sized to filter the plurality of diatom carcasses out of the funnel portion and into the carcass retaining portion below. The filtered out diatom carcasses are then removed from the diatom carcass extractor via an outlet.

The subject matter disclosed and claimed herein, in another embodiment thereof, comprises a method of treating polluted air and generating oxygen. The method employs an air cleaning system for removing pollutants from air and generating oxygen as a biproduct. The method begins by providing a plurality of diatoms in a liquid solution. The plurality of diatoms and the liquid solution are retained in a recipient vessel of the air cleaning system. Polluted air is then injected into the liquid solution in the recipient vessel via an air injecting component which may be regulated with an air regulator. The liquid solution is then aerated by an aeration component.

Next, a lighting source is used to illuminate the aerated liquid solution containing the plurality of diatoms and the injected polluted air. Then the plurality of diatoms are allowed to consume pollutants from the polluted air in the aerated liquid solution. Oxygen is produced from the plurality of diatoms via photosynthesis which diffuses out or the aerated liquid solution and is released out of the recipient vessel into the atmosphere. The method continues by removing diatom carcasses from the liquid solution via a carcass extractor.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an air cleaning system of the present invention for removing carbon dioxide from polluted air and generating oxygen as a biproduct in accordance with the disclosed architecture.

FIG. 2 illustrates a perspective view of one potential embodiment of the air cleaning system of the present invention for removing carbon dioxide from polluted air and generating oxygen as a biproduct in accordance with the disclosed architecture.

FIG. 3 illustrates a perspective view of one potential embodiment of the air cleaning system of the present invention for removing carbon dioxide from polluted air and generating oxygen as a biproduct in accordance with the disclosed architecture.

FIG. 4 illustrates a perspective view of one potential embodiment of the air cleaning system of the present invention for removing carbon dioxide from polluted air and generating oxygen as a biproduct in accordance with the disclosed architecture.

FIG. 5 illustrates a close up view of a carcass extractor of the air cleaning system of the present invention for removing carbon dioxide from polluted air and generating oxygen as a biproduct in accordance with the disclosed architecture.

FIG. 6 illustrates a close up cut away view of the base of one potential embodiment of the air cleaning system of the present invention for removing carbon dioxide from polluted air and generating oxygen as a biproduct in accordance with the disclosed architecture.

FIG. 7 illustrates a cut away view of one potential embodiment of the air cleaning system of the present invention for removing carbon dioxide from polluted air and generating oxygen as a biproduct in accordance with the disclosed architecture.

FIG. 8 illustrates a flow diagram of method of treating polluted air using one potential embodiment of an air cleaning system of the present invention for removing carbon dioxide from polluted air and generating oxygen as a biproduct in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a diatomic air cleaner and oxygen and/or water generator. The device is comprised of a generator system featuring a glass body powered by a solar panel assembly attached to one side of the globe-like glass. The solar energy can power a lamp that shines on the glass body for illuminating the system at nighttime or other lowlight day hours.

The bottom of the system features a vacuum that suctions in polluted air, an air regulator, a nanobubble pump for sea water or a regular pump for fresh water, and a diatom carcasses extractor. The middle of the device includes a funnel-like mechanism. Diatoms from the top portion are suspended in water and nano bubbles can be sucked into the bottom of the device. The top includes a clean air extractor and an exit cover that expels oxygen once cleaned by the diatoms. The diatoms convert the CO2 into clean oxygen that is expelled through the pipe at the top, back into the atmosphere.

The invention provides users with an air cleaning system that utilizes diatoms to remove CO2 from the polluted air. Users inject polluted air into water into the system to ensure the diatoms within can ‘eat’ the CO2 prior to the air being pumped back into the atmosphere as clean oxygen. The system utilizes a solar panel assembly designed to power the system and LED lights that can illuminate at nighttime or other lowlight hours of the day. An air regulator and a nanobubble pump work in conjunction to push the polluted air and water through the water in the system for cleaning via the diatoms. The system offers a simple method of generating clean, breathable oxygen.

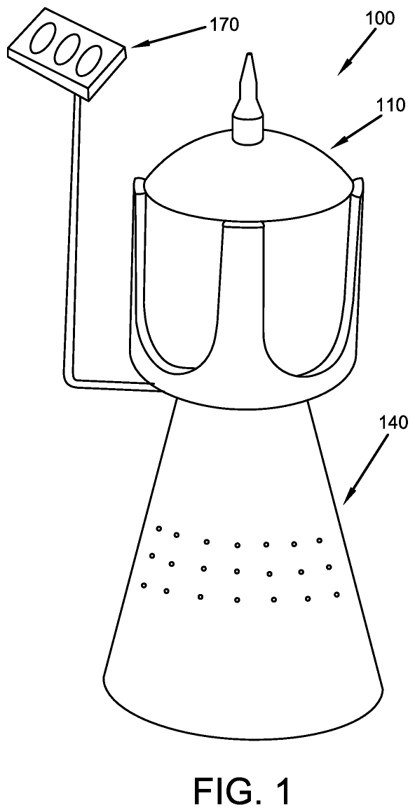

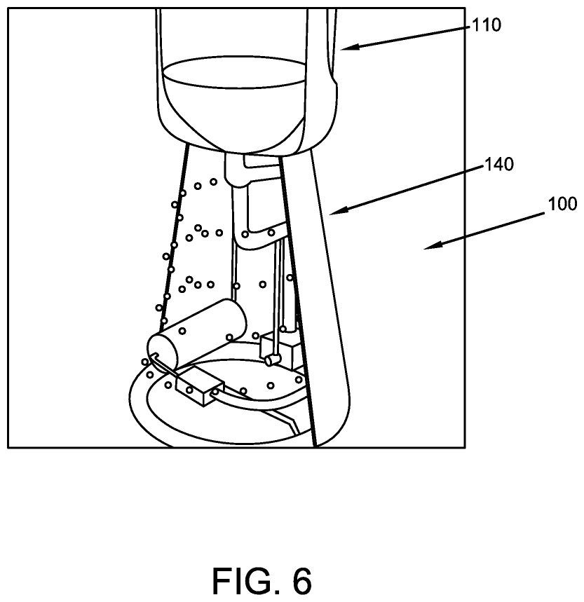

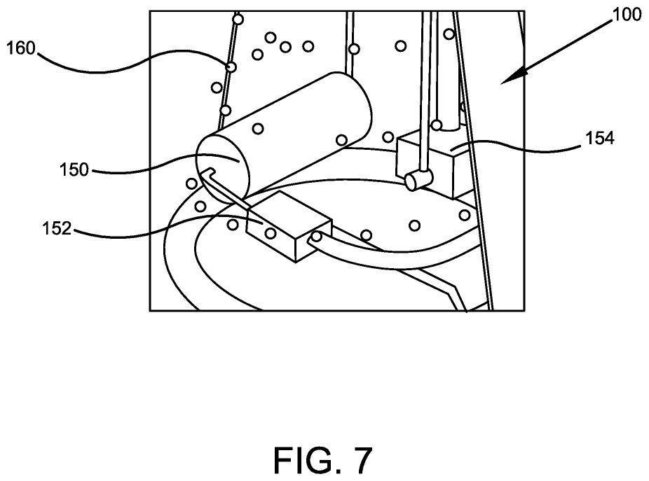

Referring initially to the drawings, FIGS. 1-7 illustrate an air cleaning system 100. The air cleaning system 100 is configured for removing carbon dioxide and other pollutants from polluted air and generating oxygen. The air cleaning system 100 uses a plurality of diatoms to consume pollutants such as CO2 in the polluted air via photosynthesis generating oxygen as a byproduct. The consumed pollutants are used by the diatoms to live and reproduce. Once deceased, the diatom carcasses are removed from the air cleaning system 100 and new diatoms may be added as needed.

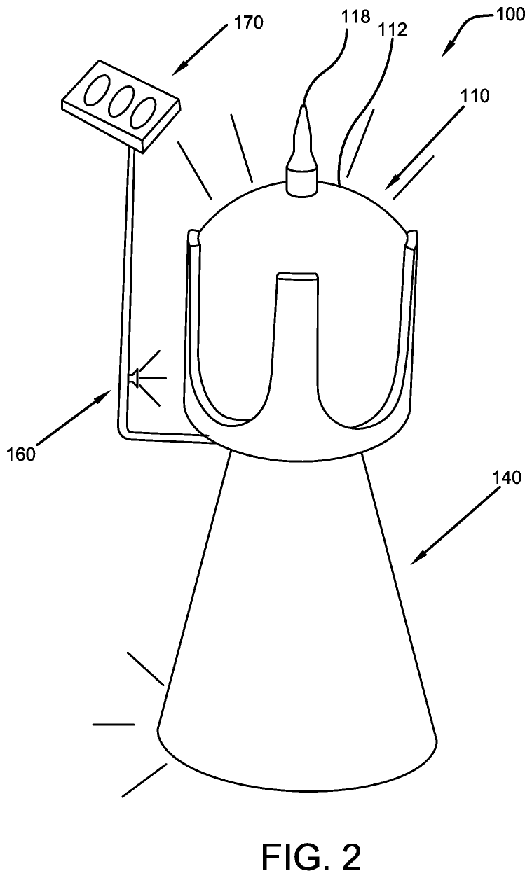

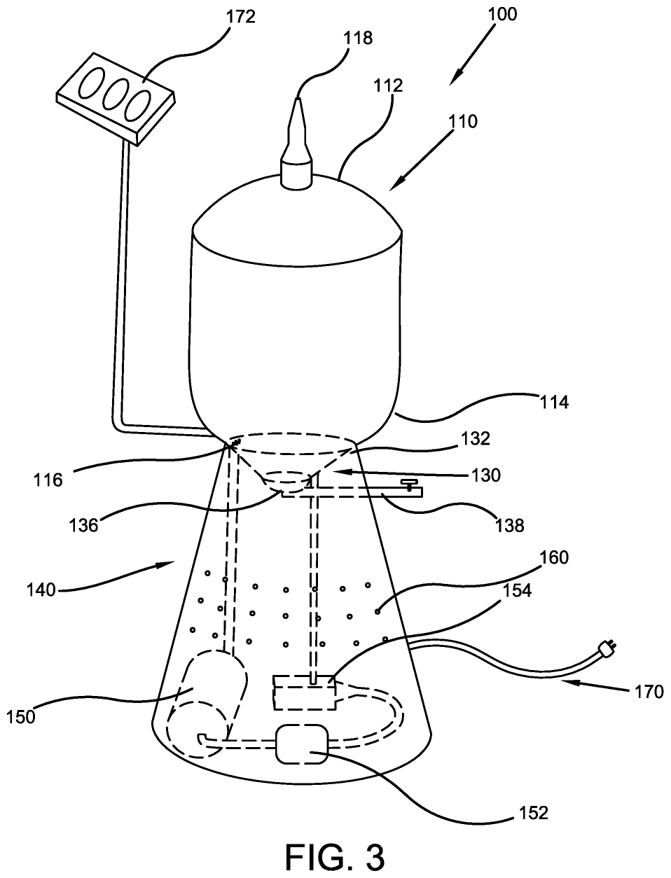

As illustrated in FIG. 1, the air cleaning system 100 comprises a recipient vessel 110. The recipient vessel 110 is transparent or translucent and configured to retain a liquid solution and the plurality of diatoms. The recipient vessel 110 may be a glass vessel. The liquid solution may be seawater or freshwater depending on the species of the plurality of diatoms used. The recipient vessel 110 may be of any size or configuration. As illustrated in FIGS. 2 and 3, the recipient vessel 110 comprises a top 112 and a bottom 114. The recipient vessel 110 further comprises an inlet 116 and an outlet 118. The outlet 118 is configured to release the generated oxygen into the atmosphere as it diffuses out of the water. Additional water is may be added through the outlet 118 in the top 112. The outlet 118 is protected by an outlet cover 120. The outlet cover 120 “umbrella's” the outlet 118 to prevent liquid or solid contaminates from entering the recipient vessel 110.

The air cleaning system 100 may further comprise a base 140. The base 140 may be of any size or configuration and is configured to support the recipient vessel 110. The base 140 is also configured to house additional components as described infra. The base 140 may be constructed form metal, cement, plastic, or a similar durable material.

As illustrated in FIGS. 3, 4, 6, and 7, the air cleaning system 100 further comprises an air injecting component 150 and an aeration component 154, typically housed within the base 140. The air injecting component 150 may be an air pump or air blower. The air injecting component 150 is configured to draw polluted air from the atmosphere into the recipient vessel 110 via the inlet 116 in the base 114 of the recipient vessel 110. The aeration component 154 may be a micro/nanobubble pump or regular air pump. The micro/nano bubble generator effectively solves gas with the water and adds it under pressure. The aeration component 154 is configured to aerate the liquid solution in the recipient vessel 110. The air cleaning system 100 may further comprise an air regulator 152, typically housed within the base 140 as well. The air regulator 152 is in fluid communication with the air injecting component 150. The air regulator 152 is configured to regulate a flow of the polluted air into the recipient vessel 110, thereby regulating a food source for the plurality of diatoms. The food source for the plurality of diatoms is the pollutants in the drawn polluted air, including CO2.

The air cleaning system 100 further comprises a lighting component 160 and a power component 170. As diatoms require light for photosynthesis to consume pollutants and generate oxygen, the lighting component 160 is used to supplement natural light or provide an independent light source during low light hours or at night, The lighting component 160 is configured to illuminate the recipient vessel 110 and may be externally located as illustrated in FIG. 2. Alternatively, the lighting component 160 could be within the base 140 as illustrated in FIG. 3. The lighting component 160 may be any type of lamp 162 or lighting including LED's. The power source 170 is configured to power the lighting component 162, the air injecting component 150, the aeration component 154, and the air regulator 152. The power source 170 may comprise a solar power element 172 or solar panel or cell. The power source 170 may also be a battery, an electrical cable, or a combination thereof. The recipient vessel 110, once lit, may act as a lamp or decorative light source.

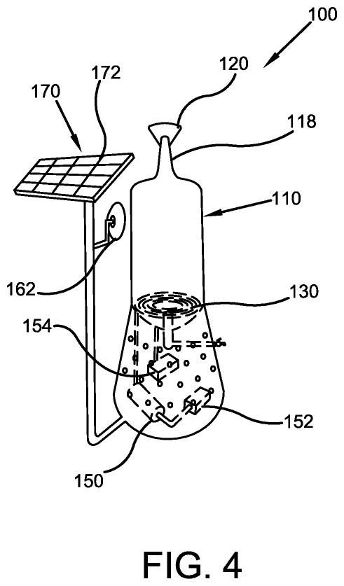

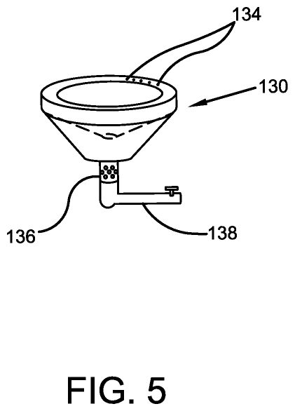

As illustrated in FIGS. 4 and 5, the air cleaning system 100 further comprises a diatom carcass extractor 130. The diatom carcass extractor 130 is housed partially within the recipient vessel 110 at the base 114 which may be funnel shaped. The diatom carcass extractor 130 comprises a funnel portion 132 and a carcass retaining portion 136. The funnel portion 132 is configured to receive a plurality of diatom carcasses as the diatoms die and flow downward in the recipient vessel 110 into the base 114. The funnel portion 132 comprises a plurality of orifices 134. The plurality of orifices 134 are generally approximately the size of a human hair in diameter and are sized to filter the plurality of diatom carcasses out of the funnel portion 132 and into the carcass retaining portion 136 below the funnel portion 132. The filtered out diatom carcasses are then completely removed from the diatom carcass extractor 130 via an outlet 138.

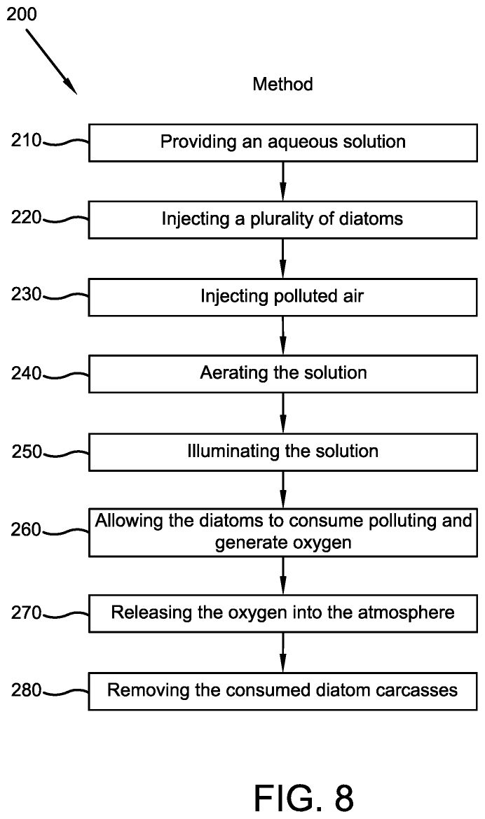

The subject matter disclosed and claimed herein, in another embodiment thereof, comprises a method 200 of treating polluted air and generating oxygen. As illustrated in FIG. 8, the method 200 employs an air cleaning system 100 for removing pollutants from air and generating oxygen as a biproduct. The method 200 begins at 210 by providing an aqueous solution, typically seawater or fresh water. At 220, a plurality of diatoms are added to the liquid solution. The plurality of diatoms and the liquid solution are retained in a recipient vessel 110 of the air cleaning system 100.

Polluted air is then injected into the liquid solution in the recipient vessel 110 via an air injecting component 150 which may be regulated with an air regulator 152 at 230. The liquid solution is then aerated by an aeration component 154, such as a nanobubble pump at 240. The air regulator 152 is configured to regulate a flow of the polluted air into the recipient vessel 110, thereby regulating a food source for the plurality of diatoms. The food source for the plurality of diatoms is the pollutants in the drawn polluted air, including CO2.

Next, a lighting source 160 is used to illuminate the aerated liquid solution containing the plurality of diatoms and the injected polluted air retained within the recipient vessel 110 at 250. Then at 260, the plurality of diatoms are allowed to consume pollutants from the polluted air in the aerated liquid solution. Oxygen is produced from the plurality of diatoms via photosynthesis which diffuses out or the aerated liquid solution and is released out of the recipient vessel into the atmosphere at 270. The method continues at 280 by removing diatom carcasses from the liquid solution in the recipient vessel 110 via a carcass extractor 130.

Notwithstanding the forgoing, the air cleaning system 100 can be any suitable size, shape, and configuration as is known in the art without affecting the overall concept of the invention, provided that it accomplishes the above stated objectives. One of ordinary skill in the art will appreciate that the shape and size of the air cleaning system 100 and its various components, as show in the FIGS. are for illustrative purposes only, and that many other shapes and sizes of the air cleaning system 100 are well within the scope of the present disclosure. Although dimensions of the air cleaning system 100 and its components (i.e., length, width, and height) are important design parameters for good performance, the air cleaning system 100 and its various components may be any shape or size that ensures optimal performance during use and/or that suits user need and/or preference. As such, the air cleaning system 100 may be comprised of sizing/shaping that is appropriate and specific in regard to whatever the air cleaning system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An air cleaning system configured to remove pollutants from air and generate oxygen as a biproduct, the air cleaning system comprising:
a recipient vessel configured to retain a liquid solution and a plurality of diatoms;
an air injecting component configured to draw polluted air into the recipient vessel;
an aeration component configured to aerate the liquid solution in the recipient vessel; and
a lighting component for illuminating the recipient vessel.

2. The air cleaning system of claim 1, wherein the recipient vessel is transparent.

3. The air cleaning system of claim 1, wherein the recipient vessel is a glass container.

4. The air cleaning system of claim 1, wherein the liquid solution is seawater.

5. The air cleaning system of claim 1, wherein the liquid solution is fresh water.

6. The air cleaning system of claim 1, wherein the air injecting component is an air pump.

7. The air cleaning system of claim 1, wherein the aeration component is a nanobubble pump.

8. The air cleaning system of claim 1, wherein the lighting component is solar powered.

9. The air cleaning system of claim 1, wherein the lighting component is externally located to the recipient vessel.

10. The air cleaning system of claim 1, wherein the recipient vessel comprises an outlet for releasing generated oxygen into the atmosphere.

11. The air cleaning system of claim 10, wherein the outlet comprises an outlet cover.

12. An air cleaning system configured to remove carbon dioxide from polluted air and generate oxygen as a biproduct, the air cleaning system comprising:
a transparent recipient vessel configured to retain a liquid solution and a plurality of diatoms;
a diatom carcass extractor housed partially within the recipient vessel;
a base for supporting the recipient vessel;
an air injecting component configured to draw polluted air into the recipient vessel;
an aeration component configured to aerate the liquid solution in the recipient vessel; and
a lighting component for illuminating the recipient vessel.

13. The air cleaning system of claim 12 further comprising an air regulator in fluid communication with the air injecting component for regulating a food source in the drawn polluted air for the diatoms.

14. The air cleaning system of claim 12 further comprising a solar power source.

15. The air cleaning system of claim 12, wherein the diatom carcass extractor comprises a funnel portion for receiving a plurality of diatom carcasses.

16. The air cleaning system of claim 15, wherein the funnel portion comprises a plurality of orifices configured to filter the diatom carcasses out of the funnel portion.

17. The air cleaning system of claim 16, wherein the diatom carcass extractor further comprises a carcass retaining portion for collecting the filtered diatom carcasses once filtered out of the funnel portion.

18. The air cleaning system of claim 12, wherein the diatom carcass extractor further comprises an outlet.

19. A method of treating polluted air and generating oxygen comprising:
providing a plurality of diatoms in a liquid solution;
injecting polluted air into the liquid solution;
aerating the liquid solution;
illuminating the liquid solution;
allowing the plurality of diatoms to consume pollutants and generate oxygen; and
releasing the generated oxygen to the atmosphere.

20. The method of claim 19 further comprising the step of removing diatom carcasses from the liquid solution
